(19) United States
(12) Patent Application Publication
(10) Pub. No.: US 2024/0370768 A1
(43) Pub. Date: Nov. 7, 2024

(54) MODEL DRIFT MANAGEMENT IN A MACHINE LEARNING ENVIRONMENT

(71) Applicant: Microsoft Technology Licensing, LLC, Redmond, WA (US)

(72) Inventors: Shujuan HUANG, Redmond, WA (US); Kiran RAMA, Bangalore (IN); Ke LI, Redmond, WA (US)

(21) Appl. No.: 18/311,672

(22) Filed: May 3, 2023

(51) Int. Cl. G06N 20/00

(52) U.S. Cl. CPC G06N 20/00

(57) ABSTRACT

A computing system extracts test data and training data from an ordered data stream and predicts doubly robust outcomes for the ordered data stream based on a combination of treatments predicted based on controls of the ordered data stream and outcomes predicted based on the treatments and the controls of the ordered data stream. The computing system measures concept drift between the test data and the training data for the machine learning model. The concept drift is measured as an expectation of differences between the doubly robust outcomes for the ordered data stream and the doubly robust outcomes for the training data. The computing system selects retraining feature vectors from feature vectors of the ordered data stream, based on the concept drift being measured to satisfy a retraining condition and retrains the machine learning model using the retraining feature vectors.

### BACKGROUND

In machine learning technology, the performance of machine learning models in production within an MLOps (machine learning operations) environment can devolve as a result of different types of drift, including data drift and concept drift. “Data drift” (also known as “covariate shift”), for example, occurs when the distribution of input data changes over time. For example, if a machine learning model was trained to predict the likelihood of customers purchasing a product based on their age and income, changes in the distribution of ages and incomes of the customers can change over time and degrade the accuracy of the model's predictions. Other examples of data drift may include, without limitation, label distribution changes, feature distribution changes, and data integrity issues.

In contrast, the term “concept drift” can be used to refer to changes in underlying relationships between the input data and the corresponding predictions. As such, concept drift refers to an evolution of data that invalidates a machine learning model when the statistical properties of the target variable or prediction objective of the model change over time. For example, the COVID pandemic changed the world in such a way that many machine learning models trained before the start of the pandemic were no longer accurate—the statistical properties of sales forecasts on business pants and shoes, for example, abruptly changed because a locked-down population was more interested in sweatpants and slippers. This change in the real-world fundamentals was not integrated into the pre-COVID machine learning models, causing the performance (e.g., accuracy) of these machine learning models to degrade, sometimes abruptly. Other examples of concept drift may include, without limitation, business rules changes, new competition in the marketplace, changes in the supply chain, and economic changes.

### SUMMARY

In some aspects, the techniques described herein relate to a method of managing model drift in a machine learning model, the method including: extracting test data and training data from an ordered data stream, the test data being extracted from a detection window in the ordered data stream and the training data being extracted from a sliding reference window that precedes the detection window in the ordered data stream; predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; measuring concept drift between the test data and the training data with respect to the machine learning model, wherein the concept drift is measured as an expectation of differences between the doubly robust outcomes for the ordered data stream and the doubly robust outcomes for the training data; selecting retraining feature vectors from feature vectors of the ordered data stream, based on the concept drift being measured to satisfy a retraining condition; and retraining the machine learning model using the retraining feature vectors, based on the concept drift being measured to satisfy the retraining condition.

In some aspects, the techniques described herein relate to a computing system for managing model drift in a machine learning model, the computing system including: one or more hardware processors; a data extractor executable by the one or more hardware processors and configured to extract test data and training data from an ordered data stream, the test data being extracted from a detection window in the ordered data stream and the training data being extracted from a sliding reference window that precedes the detection window in the ordered data stream; a doubly robust causal learning outcome predictor executable by the one or more hardware processors and configured to predict doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; a concept drive detector executable by the one or more hardware processors and configured to measure concept drift between the test data and the training data with respect to the machine learning model, wherein the concept drift is measured as an expectation of differences between the doubly robust outcomes for the ordered data stream and the doubly robust outcomes for the training data; an adversarial feature selector executable by the one or more hardware processors and configured to select retraining feature vectors from feature vectors of the ordered data stream; and a machine learning model retrainer executable by the one or more hardware processors and configured to retrain the machine learning model using the retraining feature vectors.

In some aspects, the techniques described herein relate to one or more tangible processor-readable storage media embodied with instructions for executing on one or more processors and circuits of a computing device a process of managing model drift in a machine learning model, the process including: extracting test data and training data from an ordered data stream, the test data being extracted from a detection window in the ordered data stream and the training data being extracted from a sliding reference window that precedes the detection window in the ordered data stream; predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; measuring concept drift between the test data and the training data with respect to the machine learning model, wherein the concept drift is measured as an expectation of differences between the doubly robust outcomes for the ordered data stream and the doubly robust outcomes for the training data; selecting retraining feature vectors from feature vectors of the ordered data stream, based on the concept drift being measured to satisfy a retraining condition; and retraining the machine learning model using the retraining feature vectors, based on the concept drift being measured to satisfy the retraining condition.

This summary is provided to introduce a selection of concepts in a simplified form. The concepts are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example system 100 that includes drift detection and classification in a machine learning environment.

FIG. 2 illustrates the described technology executing in a drift detection and retraining mode.

FIG. 3 illustrates additional details of the described technology relating to example doubly robust outcome prediction.

FIG. 4 illustrates example operations 400 for managing drift in a machine learning model.

FIG. 5 illustrates an example computing device 500 for use in implementing the described technology.

### DETAILED DESCRIPTION

Machine learning model designers are often interested in designing machine learning systems that are resilient to model drift, such as data drift and concept drift. However, it can be challenging to detect model drift that causes prediction errors from a machine learning model and further to determine whether the prediction errors result from data drift or concept drift. The described technology provides a computer-implemented technique, which can, in some implementations, employ “Causal Doubly Robust Adversarial Validation” or CDRav to detect and analyze drift and is related to double robust learning from the causal inference domain in combination with adversarial feature selection to distinguish concept drift from data drift. Furthermore, the impact of any concept drift can be measured and corrected by retraining if the concept drift exceeds acceptable parameters. Accordingly, the described technology provides a detection framework that can focus not only on detecting instances when drift has occurred but also on other aspects of drift, such as assessing drift type and severity, identifying affected segments of a machine learning model, and finding the root causes of such drift instances. Such detected conditions may be employed to retrain a target machine learning model to reduce or eliminate model degradation caused by such drift.

An example approach for addressing such degradation is to retrain the machine learning models with new data samples that reflect the change in real-world conditions. However, retraining can be an expensive (e.g., computer resources, time) action, which can be too late if triggered well after the model performance had degraded (resulting in prediction errors) and yet unnecessary if triggered when model performance remains accurate (resulting in wasted resources). As such, the described technology allows a producer of a machine learning model to monitor the performance of a machine learning model, identify drift-related problems with model performance, and provide insight for correcting such problems. Technical benefits of such technology yield more accurate machine learning model predictions over time, quicker resolution to machine learning model performance degradation, and higher confidence in machine learning model performance. Model accuracy can be maintained or improved over time, and the features used in retraining can be tuned to exclude some training data while retaining features that can improve the model performance, resulting in fewer but more important features being used in retraining.

The described technology can be applied to many use cases in which model drift (e.g., concept drift) can degrade the performance of a machine learning model. In the context of fraud detection, for example, concept drift refers to the changing patterns and characteristics of fraudulent behavior over time. Fraudsters are constantly coming up with new techniques and adapting their strategies to evade detection. Such malicious actors may adjust the way they use stolen credit cards or the way they create fake identities. Concept drift detection in a machine learning model pipeline involves monitoring the data over time for changes in the distribution of features that are indicative of fraud. The described technology allows the model to adapt to the changing patterns of fraudulent behavior and improve its accuracy in detecting fraudulent activities. Accordingly, for fraud detection, a system including the described technology can produce binary outcomes that indicate whether a transaction is fraudulent or not. Specifically, an outcome labeled “1” signifies that the transaction is fraudulent, while an outcome of “0” signifies that the transaction is not fraudulent. To make this determination, the system of the described technology uses a combination of control features, such as unusual transaction locations, transaction amounts and times, identification of suspicious merchant types etc. The treatment refers to the data samples of the detection time window versus data samples of the sliding reference time window, as described below.

When applied to healthcare, a machine learning model may be used to predict the risk of hospital readmissions for patients with congestive heart failure (CHF). The model is trained on a dataset of patient records from the previous year, which includes information such as the patient's age, gender, medical history, lab results, and medications. Over time, the characteristics of the patient population with CHF may change as new treatments become available and new risk factors emerge. For example, if a new medication for CHF is introduced, it may exhibit a significant impact on reducing readmissions, which can lead to changes in the distribution of features in the input data, such as a decrease in the number of patients with certain risk factors or an increase in the use of the new medication. If the machine learning model does not account for these changes, it may become less accurate over time. By detecting such concept drift in the data, the machine learning model can adapt to the changing distribution of features and improve its accuracy in predicting readmissions. Accordingly, for certain healthcare applications, a system including the described technology can produce binary outcomes that indicate the risk of hospital readmissions for patients with congestive heart failure (CHF). To make this determination, the system can use a combination of control features, such as age, gender, medical history, lab results, medications etc. The treatment refers to the data samples of the detection time window versus data samples of the sliding reference time window, as described below.

When applied to website personalization, concept drift refers to the changing preferences and behavior of website visitors over time. Visitors' interests and preferences may change as they interact with the website, and the machine learning model preferably adapts to these changes to provide relevant content and recommendations. By detecting concept drift, the model can update its understanding of visitor behavior and preferences and improve its ability to personalize the website experience. Accordingly, for website personalization, a system including the described technology can produce a list of recommendations for a visitor. To make this determination, the system uses a combination of control features, such as browsing history including duration of visit, device and location data, time and date stamps, search sequences etc. The system can further produce binary outcomes that indicate the risk of hospital readmissions for patients with congestive heart failure (CHF). To make this determination, the system uses a combination of control features, such as age, gender, medical history, lab results, medications etc. The treatment refers to the data samples of the detection time window versus data samples of the sliding reference time window, as described below.

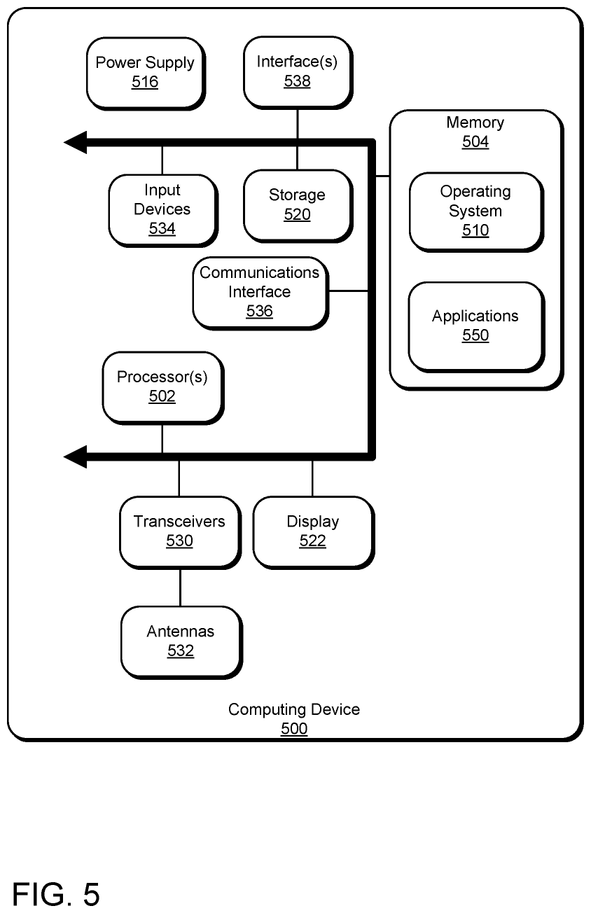

It should be understood that elements of the described technology (e.g., a machine learning model trainer, a data drift detector, ad concept drift detector, and the trained/retrained instances of a machine learning model) may be executed in a single computing device, individually in separate computing devices, or across a distributed collections of computing devices, such as a computing device illustrated in and describe with respect to FIG. 5. In one example, the machine learning model is retrained in situ, such as in a medical imaging system or post-processing system, in parallel with the medical image processing, or within a datacenter or other computing environment. However, the model can also be uploaded to a retraining system, retrained, and then installed back into the processing system. In various implementations, the described retraining machine learning models can be applied to weather predictions, disease tracking, medical patient diagnosis and treatment, autonomous vehicles, online data searches, resource scheduling, recommendations, and other use cases.

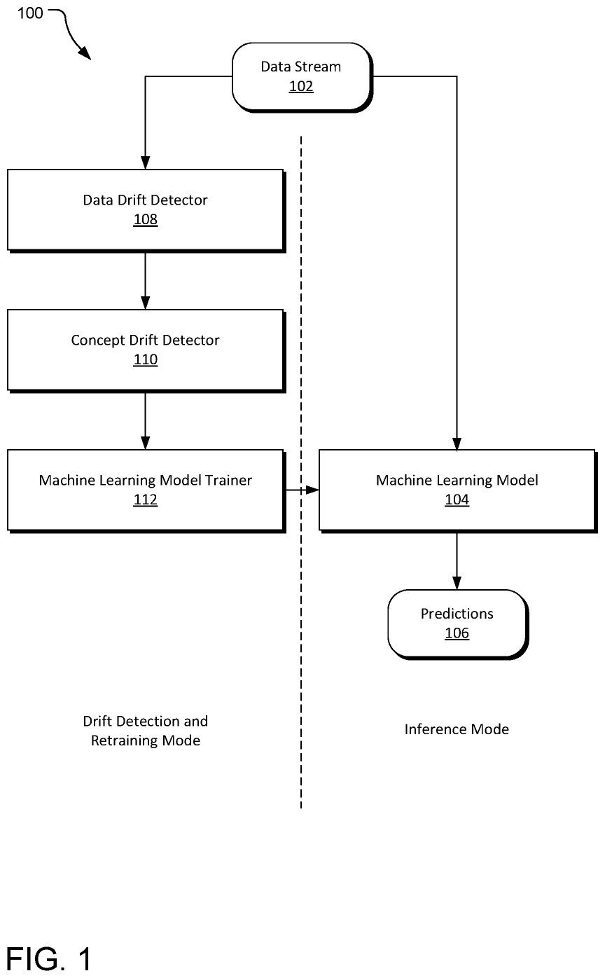

FIG. 1 illustrates an example system 100 that includes drift detection and classification in a machine learning environment. The system 100 receives a data stream 102 (e.g., a stream of data samples received over time) that is input to a machine learning model 104 to generate predictions 106 in an inference mode. In a drift detection and retraining mode, the described technology detects model drift, notably isolating concept drift between the test data and the training data with respect to the machine learning model 104 and the data stream 102 and retrains the machine learning model 104 with selected feature vectors of the data stream 102, which can be stored in a data structure in memory. In this manner, the machine learning model 104 can be updated to resolve the impact of concept drift and therefore maintain model performance.

Generally, the term “hyperparameters,” as used herein with respect to machine learning, refers to a parameter having a value that is used to control the learning process and the model selection task of a machine learning algorithm. Hyperparameters are set by the user or machine learning model designer before applying the machine learning algorithm to a dataset. Hyperparameters are not learned from the training data or part of the resulting model. Examples of hyperparameters are the topology and size of a neural network, the learning rate, and the batch size. Hyperparameter tuning is finding the optimal values of hyperparameters for the best performance of the algorithm.

In contrast, a machine learning model is also characterized by model parameters (also referred to as “parameters”) that are learned during a training or retraining operation. These parameters include, for example, the weights and biases formed by the algorithm as it is being trained and are intended to ideally fit a data set without going over or under.

A data drift detector 108 monitors the data samples in the data stream 102 to determine whether the data samples exhibit data drift. When monitoring the data stream 102, the data drift detector 108 monitors two separate time windows within the data stream 102, a sliding reference time window and a detection time window. In one implementation, the sliding reference time window includes data samples earlier in time than the detection time window. For example, if the current time is labeled as 1, an example sliding reference time window can be selected to range from t−36 months to t−6 months, and an example detection time window can be selected to range from t−6 months to t. The data samples are labeled with a variable Tᵢ, such that data samples from the sliding reference time window are labeled with Tᵢ=0 and data samples from the detection window are labeled with Tᵢ=1. The data sample and the labels can be stored in a data structure in memory.

Input data from the data stream typically changes over time, often in unpredictable ways, but not every occurrence of data drift leads to model performance degradation. For example, when data drift occurs on less important features, the machine learning model may respond robustly, and model performance is not affected. Accordingly, the data drift detector 108 evaluates the data samples from the two time windows to evaluate whether data drift is expected to lead to model performance degradation.

When data drift expected to degrade model performance occurs, the data drift detector 108 first evaluates whether the data drift results from data integrity issues, such as erroneous data received from a data source, faulty data engineering, etc. If the data drift detector 108 determines that the data drift results from data integrity issues, these root causes of incorrect data are addressed outside the scope of the described technology.

Alternatively, if the detected data drift is not determined to be the result of a data integrity issue, then the data drift is attributed to real data changes within the data stream 102. The data drift detector 108 tracks the distributions of features and predictions over time by evaluating data samples in the detection time window against data samples in the sliding reference time window or uses time series anomaly detection to receive warning of emerging drift. In various implementations, the data drift detector 108 can employ various data drift monitoring techniques through unsupervised learning, including without limitation:
Kullback-Leibler (KL) Divergence: KL Divergence measures the differences of one probability distribution to a reference probability distribution.
Jensen-Shannon distance: The Jenson-Shannon divergence is a method of measuring the similarity between two probability distributions. It is based on the Kullback-Leibler divergence, with some notable and useful differences, including that it is symmetric and has a finite value. The square root of the Jensen-Shannon divergence is a metric often referred to as Jensen-Shannon distance.
Two Sample Kolmogorov-Smirnov test: This test involves an evaluation metric that examines the greatest separation between the cumulative distribution of a test distribution relative to a reference distribution. In addition, this metric can be used like a z-score against the Kolmogorov distribution to perform a hypothesis test as to whether the test distribution is the same distribution as the reference.
Population Stability Index (PSI): The PSI compares the current scoring variable to the predicted probability from training data.
KDE intersection plot: In statistics, kernel density estimation (KDE) is a non-parametric way to estimate the probability density function (PDF) of a random variable. This function uses Gaussian kernels and includes automatic bandwidth determination.

Using such analytical techniques, the data drift detector 108 measures the difference in the data distributions in each window and determines whether the difference metric satisfies a degradation condition, which can trigger retraining of the machine learning model 104 using data samples from the detection window or other newer data samples. For example, a Kolmogorov-Smirnov (KS) Test can be used in data drift to detect changes in the probability distribution of a variable. The KS Test calculates the maximum difference between the cumulative distribution functions of two samples and generates a p-value indicating the probability of observing such a difference by chance. If the p-value obtained from the Kolmogorov-Smirnov (KS) Test is less than the chosen significance level of 0.05, it means that there is sufficient evidence to reject the null hypothesis that the two samples being compared are drawn from the same distribution. In other words, it suggests that there is a significant difference between the probability distributions of the two samples being compared, indicating the presence of data drift.

If a measure of the detected data drift does not satisfy a data drift condition (e.g., does not exceed a defined threshold, indicating that the data drift is small enough to have little impact on model performance), a concept drift detector 110 can address potential concept drift without separating data drift from concept drift. However, if the measure of detected data drift does satisfy a data drift condition (e.g., exceeds a defined threshold, indicating that the data drift is large enough to have substantial impact on model performance), the concept drift detector 110 in various implementations uses causal doubly robust adversarial validation (CDRav) to separate the impact of data drift from concept drift and to select retraining data from newer data samples for use in retraining to adapt the machine learning model for the detected concept drift, thereby maintaining model performance (e.g., accuracy). Accordingly, the concept drift detector 110 can detect the instance in which concept drift is present, assess the impact of the concept drift, identify affected segments of the machine learning model, determine the root causes of the degradation effects, and identify retraining data for retraining the model in the presence of such drift. The identified retraining data can be stored in a data structure in memory.

The concept drift detector 110 evaluates the data samples in the sliding reference time window and the detection time window to determine whether the data samples from the data stream 102 exhibit concept drift. There are many sources of overfitting that can impact a machine learning model's long-term accuracy and robustness. For example, training a model with data distributions that are very different from the test or production data distributions can lead to poor model performance. Even slight differences in the data distributions can significantly degrade model accuracy.

In at least one implementation, an adversarial approach using doubly robust learning is a type of causal inference that can be used to detect concept drift in a machine learning environment. Causal inference refers to inferring the effects of any treatment on an outcome that can involve a treatment group and a control group with similar confounding feature values but different treatments.

In causal learning, an outcome is a variable that is measured to determine whether it is affected by a treatment or exposure, and a treatment is an intervention that is applied to a group of subjects in order to determine its effect on the outcome of interest. A control is a variable that is manipulated by an experimenter to determine whether it has an effect on the outcome of interest. In other words, a control can be a variable that is held constant in order to isolate the effect of another variable. For example, if a researcher wants to know whether a new drug works better than an old one, the researcher might give one group of patients the new drug (the treatment group) and another group the old drug (the control group) and compare their outcomes. By comparing the differences in the outcome between the two groups, the treatment impact can be assessed.

In use cases contemplated for the described technology, causal learning can be used to assist with matching the distribution features of data samples from the two time windows and to net out the impact of other confounding factors, such as data drift, so that the remaining differences of the prediction outcomes can be attributed directly to concept drift to model performance degradation. Accordingly, by controlling the confounding factors, such as label distribution change, feature distribution change, etc.), the model performance metrics among the treatment group and the control group are compared to detect the impact of concept drift.

As such, the concept drift detector 110 receives time-based data samples from the data stream, separated into the sliding reference time window and the detection time window. The concept drift detector 110 includes a machine learning model, denoted as gₜ(Xᵢ), for predicting outcomes treatments and controls, and another machine learning model, denoted as pₜ(Xᵢ) for predicting treatments from the controls, providing a propensity score Pr[T=t|Xᵢ] for the treatments over the controls, where T represents each treatment, t represents type value of treatment, and i represents a unit (e.g., patient) index. The concept drift detector 110 combines these models. These machine learning models are combined in a final stage estimation to create a model of the heterogeneous treatment effect. In particular, the described technology fits a direct regression model and then debiases that model by applying an Inverse Propensity approach to the residual of that model.

An output of the concept drift detector 110 is a measure of the concept drift θₜ(X) detected between the machine learning model 104 and the data stream 102. If the measure of the concept drift satisfies a retraining condition (e.g., the measure of concept exceeds a defined threshold), the concept drift detector 110 selects feature vectors of the data stream 102 for use in training the machine learning model 104 to resolve the concept drift and maintain model performance. The selected feature vectors from the concept drift detector 110 can be stored in a data structure in memory and are further input to a machine learning model retrainer 112 to execute the retraining of the machine learning model 104, after which the data stream 102 can be input for prediction by the machine learning model 104 in an inference mode.

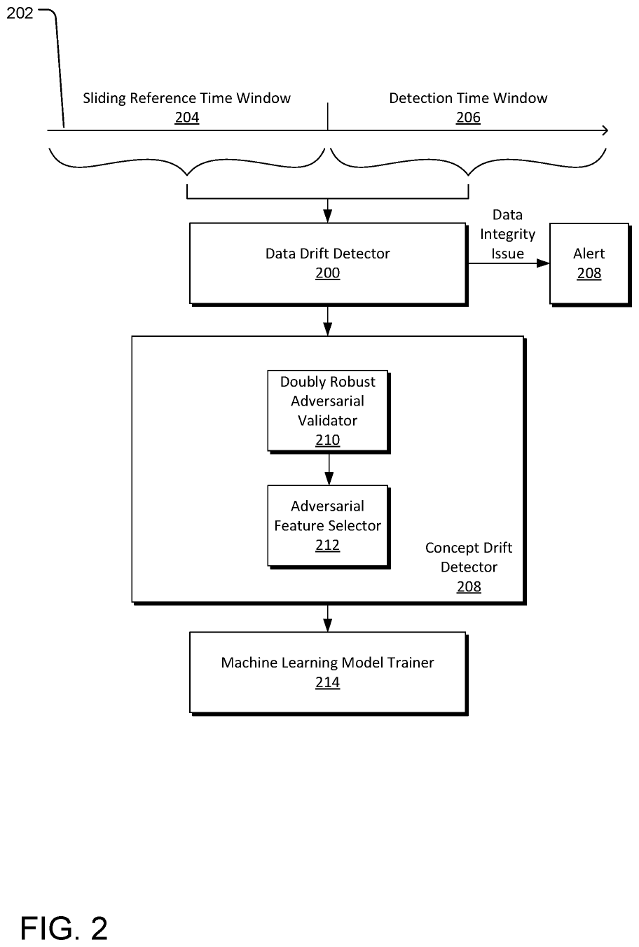

FIG. 2 illustrates the described technology executing in a drift detection and retraining mode. A data drift detector 200 monitors the data samples in an ordered data stream 202 (e.g., a time-ordered data stream) to determine whether the data samples exhibit data drift. When monitoring the ordered data stream 202, the data drift detector 200 monitors two separate time windows within the ordered data stream 202, a sliding reference time window 204, which includes observed outcomes, and a detection time window 206, for which predicted outcomes are desired. As previously described, if the data drift detector 200 detects data drift of concern and determines that the data drift is a result of a data integrity issue, the described technology issues an alert to engineering to analyze data sources and further terminates. If, in the alternative, no data drift is detected or the detected data drift is determined to not be a result of a data integrity issue, the data drift detector 200 passes a measure of the detected data drift to a concept drift detector 208.

If the measure of detected data drift is determined data drift does not satisfy a data drift condition (e.g., does not exceed a defined threshold, indicating that the data drift is small enough to have little impact on model performance), the concept drift detector 208 can address potential concept drift without separating data drift from concept drift. However, if the measure of detected data drift does satisfy a data drift condition (e.g., exceeds a defined threshold, indicating that the data drift is large enough to have substantial impact on model performance), the concept drift detector 208 in various implementations uses causal doubly robust adversarial validation (CDRav) to separate the impact of data drift from concept drift and to select retraining data from newer data samples for use in retraining to adapt the machine learning model for the detected concept drift, thereby maintaining model performance (e.g., accuracy).

In a first phase of concept drift detection, the concept drift detector 208 executes a doubly robust adversarial validator 210 based, in part, on doubly robust learning. The doubly robust adversarial validator 210 executes machine learning models performing different predictive tasks:
Predictive task (1): predicting the output Yᵢ from the treatment Tᵢ and model features (controls) Xᵢ, where Xᵢ can be hid-dimensional data
Predictive task (2): predicting the treatment Tᵢ and controls Xᵢ

Doubly robust learning combines these two predictive models in a final stage estimation to create a model of the heterogeneous treatment effect. In particular, the model fits a direct regression model but then debiases that model by applying an inverse propensity weighting to the residual of that model. As such, the following estimate of the potential outcomes is constructed (referred to as doubly robust outcomes Y_{i,t}^{DR})

$${Y}_{i , t}^{D R} = {g}_{t} ( {X}_{i} ) + \frac{{Y}_{i} - {g}_{t} ( {X}_{i} )}{{p}_{t} ( {X}_{i} )} \cdot 1 \{ {T}_{i} = t \} \qquad ( 1 )$$

where Y^{(t)}=gₜ(Xᵢ)+eₜ, gₜ(Xᵢ) are the outcomes predicted by the predictive task 1, eₜ is the error in the predicted outcomes compared to the observed outcomes, E[e|X]=0 where E[ ] represents an expectation, Yᵢ−gₜ(Xᵢ) are the residuals, and pₜ(Xᵢ)=Pr[T=t|Xᵢ] is the propensity score modeled by the predictive task 2. The impact from the concept drift θₜ(X) is defined as an expectation of the predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data;

$${θ}_{t} ( X ) = E [ {Y}^{( t )} - {Y}^{( 0 )} \vert X ] \qquad ( 2 )$$

which represents an expectation of differences between the doubly robust outcomes for the ordered data stream and the doubly robust outcomes for the training data and can be obtained by regressing Y_{i,t}^{DR}−Y_{i,0}^{DR} on Xᵢ.

Having measured the concept drift θₜ(X), as separated from any data drift, the doubly robust adversarial validator 210 determines whether the concept drift θₜ(X) satisfies a retraining condition (e.g., exceeds a defined threshold). If not, the concept drift detector 208 can exit the drift detection and retraining mode, and the target machine learning model can proceed with predicting outcomes in an inference mode.

Alternatively, if the concept drift θₜ(X) satisfies the retraining condition, an adversarial feature selector 212 executes as an adversarial classifier to separate the training data from the test data. The adversarial feature selector 212 can generate an area-under-the-curve (AUC) score for each data sample and exclude a set of higher-scoring feature vectors of the data stream from use in retraining the target machine learning model. However, there is a trade-off between losing relevant training information by dropping features from the model and reducing the size of the training data. Accordingly, before selecting the retraining data that exhibit concept drift between the training data and the test data with respect to the target machine learning model, the adversarial feature selector 212 further filters the candidate features (e.g., candidates for being dropped from the retraining data).

Accordingly, the adversarial feature selector 212 determines the number of features to exclude from the retraining data based on the performance of its adversarial classifier (which generates an AUC score for each feature vector), raw feature importance values (e.g., gains in boosting trees), and raw permutation feature importance values. An AUC calculator measures the entire two-dimensional area underneath a curve showing the performance of a classification model for all classification thresholds (e.g., a receiver operating characteristic or ROC curve). A feature importance calculator generates raw feature importance values, which are scores representing relationships between independent variables (e.g., features) and dependent variables (e.g., outcomes), effectively measuring how much each feature impacts the value of the outcome. In contrast, a permutation importance calculator generates raw permutation feature importance values, which are measures of the importance of features to predictions by the machine learning model by shuffling the values of one feature at a time and observing the change in the model's predicted outcome.

The adversarial feature selector 212 trains its adversarial classifier to separate training data and test data. If the AUC score of the adversarial classifier satisfies an AUC condition (e.g., is greater than a defined AUC threshold τ_{AUC}), the adversarial feature selector 212 filters the candidate features by removing features ranked within top m % of remaining features in adversarial classifier feature importance ranking, removing features with raw feature importance values higher than a threshold τ_{raw}, and removing features not in top n % of raw permutation feature importance. The defined thresholds of m, n, τ_{AUC}, and τ_{raw} are hyperparameters that can be tuned during model training. The retained features are used as a new set of candidate features in one or more subsequent iterations of the adversarial classifier training and the filtering until the AUC score drops satisfies the AUC condition. Accordingly, the adversarial feature selector 212 selects retraining feature vectors from candidate feature vectors of the ordered data stream.

After the AUC score drops to satisfy the AUC condition for a set of candidate features, the selected retraining feature vectors are used by a machine learning model trainer 214 to retrain the target machine learning model. Thereafter, the target machine learning model can be used in inference mode to predict new outcomes from the test data in the detection time window 206.

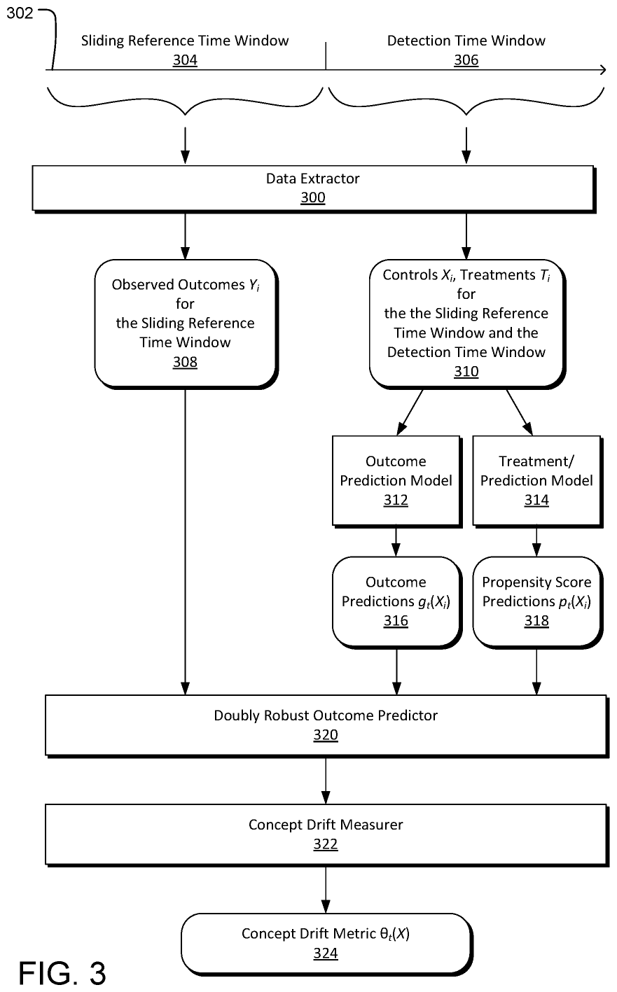

FIG. 3 illustrates additional details of the described technology relating to example doubly robust outcome prediction. A data extractor 300 extracts data samples from multiple windows in an ordered data stream 302 (e.g., a time-ordered data stream). In one implementation, a sliding reference time window 304, which includes observed outcomes, and a detection time window 306, for which predicted outcomes are desired. The data extractor 300 outputs observed outcomes Yᵢ for the sliding reference time window 304 (represented as data 308) and outputs controls Xᵢ and treatments Tᵢ for the sliding reference time window 304 and the detection time window 306 (represented as data 310).

The controls Xᵢ and treatments Tᵢ of data 310 are input to an outcome prediction model 312 for executing the previously described predictive task 1 to generate the outcome predictions gₜ(Xᵢ) 316 and to a treatment prediction model 314 for executing the described predicted task 2 to generate the propensity scores predictions pₜ(Xᵢ) 318. A doubly robust outcome predictor 320 generates doubly robust outcomes for the ordered data stream based on a combination of treatments predicted based on controls of the ordered data stream 302 and outcomes predicted based on the treatments and the controls of the ordered data stream 302, wherein the doubly robust outcomes include doubly robust outcomes for the test data and doubly robust outcomes for the training data, such as according to Equation (1). A concept drift measurer 322 determines the impact of concept drift θₜ(X) 324, such as according to Equation (2).

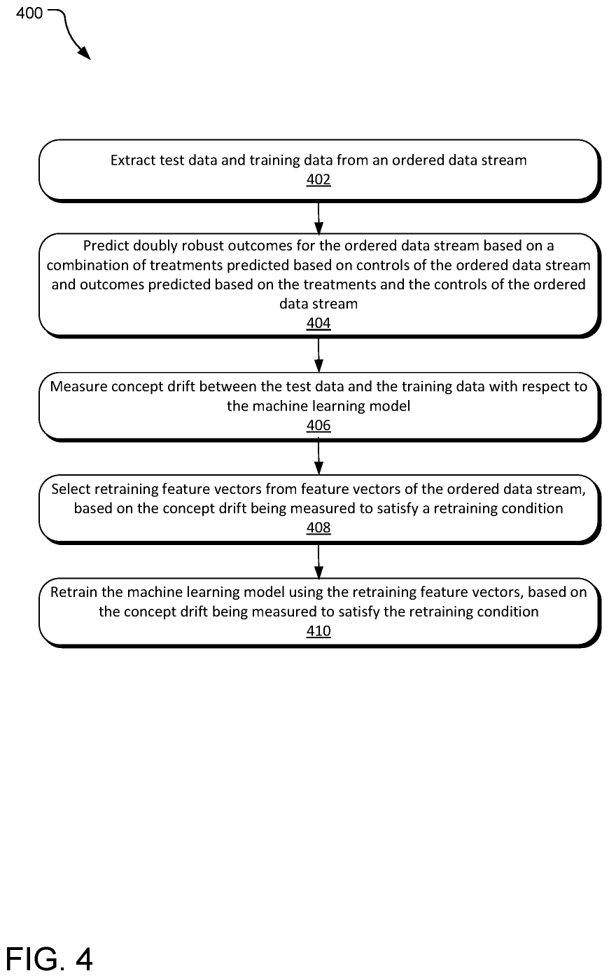

FIG. 4 illustrates example operations 400 for managing drift in a machine learning model. An extraction operation 402 extracts test data and training data from an ordered data stream. The test data is extracted from a detection window in the ordered data stream, and the training data is extracted from a sliding reference window that precedes the detection window in the ordered data stream. A prediction operation 404 predicts doubly robust outcomes for the ordered data stream based on a combination of treatments predicted based on controls of the ordered data stream and outcomes predicted based on the treatments and the controls of the ordered data stream. The doubly robust outcomes include doubly robust outcomes for the test data and doubly robust outcomes for the training data (see, e.g., Equation (1)). In one implementation, the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream. In some such implementations, the inverse propensity weighting of the residuals is based on the treatments predicted based on the controls of the ordered data stream.

A measuring operation 406 measures concept drift between the test data and the training data with respect to the machine learning model. The concept drift is measured as an expectation of differences between the doubly robust outcomes for the ordered data stream and the doubly robust outcomes for the training data (see, e.g., Equation (2)).

A selecting operation 408 selects retraining feature vectors from feature vectors of the ordered data stream, based on the concept drift being measured to satisfy a retraining condition. In some implementations, the retraining feature vectors are selected based on scores generated by an adversarial feature classifier. In some implementations, the retaining feature vectors are selected the retraining feature vectors based on an area-under-the-curve (AUC) score generated by the adversarial feature classifier and an AUC condition hyperparameter. In some implementations, the retraining feature vectors are selected based on a raw feature importance value and a raw feature importance condition hyperparameter. In some implementations, the retraining feature vectors are selected based on a raw permutation feature importance value and a raw permutation feature importance condition hyperparameter.

A retraining operation 410 retrains the machine learning model using the retraining feature vectors, based on the concept drift being measured to satisfy the retraining condition.

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more processor(s) 502 and a memory 504. The memory 504 generally includes both volatile memory (e.g., RAM) and nonvolatile memory (e.g., flash memory), although one or the other type of memory may be omitted. An operating system 510 resides in the memory 504 and is executed by the processor(s) 502. In some implementations, the computing device 500 includes and/or is communicatively coupled to storage 520.

In the example computing device 500, as shown in FIG. 5, one or more modules or segments, such as applications 550, a data drift detector, a concept drift detector, a machine learning model trainer, a machine learning model, a doubly robust adversarial validator, an adversarial feature selector, a data extractor, an outcome prediction model, a treatment prediction model, a doubly robust outcome predictor, a concept drift measurer, and other program code and modules are loaded into the operating system 510 on the memory 504 and/or the storage 520 and executed by the processor(s) 502. The storage 520 may store a data stream, predictions, observed outcomes, predicted outcomes, controls, treatments, AUC scores, raw feature importance values, raw permutation feature importance values, thresholds, conditions, and other data and be local to the computing device 500 or may be remote and communicatively connected to the computing device 500. In particular, in one implementation, components of a system for managing model drift in a machine learning model may be implemented entirely in hardware or in a combination of hardware circuitry and software.

The computing device 500 includes a power supply 516, which may include or be connected to one or more batteries or other power sources, and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). The computing device 500 may further include a display 522, such as a touchscreen display.

The computing device 500 may include a variety of tangible processor-readable storage media and intangible processor-readable communication signals for implementing a computer-executable process. Tangible processor-readable storage can be embodied by any available media that can be accessed by the computing device 500 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of managing model drift in a machine learning model, the method comprising: extracting test data and training data from an ordered data stream, the test data being extracted from a detection window in the ordered data stream and the training data being extracted from a sliding reference window that precedes the detection window in the ordered data stream; predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; measuring concept drift between the test data and the training data with respect to the machine learning model, wherein the concept drift is measured as an expectation of differences between the doubly robust outcomes for the ordered data stream and the doubly robust outcomes for the training data; selecting retraining feature vectors from feature vectors of the ordered data stream, based on the concept drift being measured to satisfy a retraining condition; and retraining the machine learning model using the retraining feature vectors, based on the concept drift being measured to satisfy the retraining condition.

Clause 2. The method of clause 1, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

Clause 3. The method of clause 2, wherein the inverse propensity weighting of the residuals is based on the treatments predicted based on the controls of the ordered data stream.

Clause 4. The method of clause 1, wherein the selecting operation comprises: selecting the retraining feature vectors based on scores generated by an adversarial feature classifier.

Clause 5. The method of clause 4, wherein the selecting operation comprises: selecting the retraining feature vectors based on an area-under-the-curve (AUC) score generated by the adversarial feature classifier and an AUC condition hyperparameter.

Clause 6. The method of clause 4, wherein the selecting operation comprises: selecting the retraining feature vectors based on a raw feature importance value and a raw feature importance condition hyperparameter.

Clause 7. The method of clause 4, wherein the selecting operation comprises: selecting the retraining feature vectors based on a raw permutation feature importance value and a raw permutation feature importance condition hyperparameter.

Clause 8. A computing system for managing model drift in a machine learning model, the computing system comprising: one or more hardware processors; a data extractor executable by the one or more hardware processors and configured to extract test data and training data from an ordered data stream, the test data being extracted from a detection window in the ordered data stream and the training data being extracted from a sliding reference window that precedes the detection window in the ordered data stream; a doubly robust causal learning outcome predictor executable by the one or more hardware processors and configured to predict doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; a concept drift detector executable by the one or more hardware processors and configured to measure concept drift between the test data and the training data with respect to the machine learning model, wherein the concept drift is measured as an expectation of differences between the doubly robust outcomes for the ordered data stream and the doubly robust outcomes for the training data; an adversarial feature selector executable by the one or more hardware processors and configured to select retraining feature vectors from feature vectors of the ordered data stream; and a machine learning model retrainer executable by the one or more hardware processors and configured to retrain the machine learning model using the retraining feature vectors.

Clause 9. The computing system of clause 8, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

Clause 10. The computing system of clause 9, wherein the inverse propensity weighting of the residuals is based on the treatments predicted based on the controls of the ordered data stream.

Clause 11. The computing system of clause 8, wherein the adversarial feature selector is further configured to select the retraining feature vectors based on scores generated by an adversarial feature classifier.

Clause 12. The computing system of clause 11, wherein the adversarial feature selector is further configured to select the retraining feature vectors based on an area-under-the-curve (AUC) score generated by the adversarial feature classifier and an AUC condition hyperparameter.

Clause 13. The computing system of clause 11, wherein the adversarial feature selector is further configured to select the retraining feature vectors based on a raw feature importance value and a raw feature importance condition hyperparameter.

Clause 14. The computing system of clause 11, wherein the adversarial feature selector is further configured to select the retraining feature vectors based on a raw permutation feature importance value and a raw permutation feature importance condition hyperparameter.

Clause 15. One or more tangible processor-readable storage media embodied with instructions for executing on one or more processors and circuits of a computing device a process of managing model drift in a machine learning model, the process comprising: extracting test data and training data from an ordered data stream, the test data being extracted from a detection window in the ordered data stream and the training data being extracted from a sliding reference window that precedes the detection window in the ordered data stream; predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; measuring concept drift between the test data and the training data with respect to the machine learning model, wherein the concept drift is measured as an expectation of differences between the doubly robust outcomes for the ordered data stream and the doubly robust outcomes for the training data; selecting retraining feature vectors from feature vectors of the ordered data stream, based on the concept drift being measured to satisfy a retraining condition; and retraining the machine learning model using the retraining feature vectors, based on the concept drift being measured to satisfy the retraining condition.

Clause 16. The one or more tangible processor-readable storage media of clause 15, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

Clause 17. The one or more tangible processor-readable storage media of clause 16, wherein the inverse propensity weighting of the residuals is based on the treatments predicted based on the controls of the ordered data stream.

Clause 18. The one or more tangible processor-readable storage media of clause 15, wherein the selecting operation comprises: selecting the retraining feature vectors based on scores generated by an adversarial feature classifier.

Clause 19. The one or more tangible processor-readable storage media of clause 18, wherein the selecting operation comprises: selecting the retraining feature vectors based on an area-under-the-curve (AUC) score generated by the adversarial feature classifier and an AUC condition hyperparameter.

Clause 20. The one or more tangible processor-readable storage media of clause 18, wherein the selecting operation comprises: selecting the retraining feature vectors based on a raw permutation feature importance value and a raw permutation feature importance condition hyperparameter.

Clause 21. A system for managing model drift in a machine learning model, the system comprising: means for extracting test data and training data from an ordered data stream, the test data being extracted from a detection window in the ordered data stream and the training data being extracted from a sliding reference window that precedes the detection window in the ordered data stream; means for predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data; means for measuring concept drift between the test data and the training data with respect to the machine learning model, wherein the concept drift is measured as an expectation of differences between the doubly robust outcomes for the ordered data stream and the doubly robust outcomes for the training data; means for selecting retraining feature vectors from feature vectors of the ordered data stream, based on the concept drift being measured to satisfy a retraining condition; and means for retraining the machine learning model using the retraining feature vectors, based on the concept drift being measured to satisfy the retraining condition.

Clause 22. The system of clause 21, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

Clause 23. The system of clause 22, wherein the inverse propensity weighting of the residuals is based on the treatments predicted based on the controls of the ordered data stream.

Clause 24. The system of clause 21, wherein the means for selecting comprises: means for selecting the retraining feature vectors based on scores generated by an adversarial feature classifier.

Clause 25. The system of clause 24, wherein the means for selecting comprises: means for selecting the retraining feature vectors based on an area-under-the-curve (AUC) score generated by the adversarial feature classifier and an AUC condition hyperparameter.

Clause 26. The system of clause 24, wherein the means for selecting comprises: means for selecting the retraining feature vectors based on a raw feature importance value and a raw feature importance condition hyperparameter.

Clause 27. The system of clause 24, wherein the means for selecting comprises: means for selecting the retraining feature vectors based on a raw permutation feature importance value and a raw permutation feature importance condition hyperparameter.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of managing model drift in a machine learning model, the method comprising:
extracting test data and training data from an ordered data stream, the test data being extracted from a detection window in the ordered data stream and the training data being extracted from a sliding reference window that precedes the detection window in the ordered data stream;
predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data;
measuring concept drift between the test data and the training data with respect to the machine learning model, wherein the concept drift is measured as an expectation of differences between the doubly robust outcomes for the ordered data stream and the doubly robust outcomes for the training data;
selecting retraining feature vectors from feature vectors of the ordered data stream, based on the concept drift being measured to satisfy a retraining condition; and
retraining the machine learning model using the retraining feature vectors, based on the concept drift being measured to satisfy the retraining condition.

2. The method of claim 1, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

3. The method of claim 2, wherein the inverse propensity weighting of the residuals is based on the treatments predicted based on the controls of the ordered data stream.

4. The method of claim 1, wherein the selecting operation comprises:
selecting the retraining feature vectors based on scores generated by an adversarial feature classifier.

5. The method of claim 4, wherein the selecting operation comprises:
selecting the retraining feature vectors based on an area-under-the-curve (AUC) score generated by the adversarial feature classifier and an AUC condition hyperparameter.

6. The method of claim 4, wherein the selecting operation comprises:
selecting the retraining feature vectors based on a raw feature importance value and a raw feature importance condition hyperparameter.

7. The method of claim 4, wherein the selecting operation comprises:
selecting the retraining feature vectors based on a raw permutation feature importance value and a raw permutation feature importance condition hyperparameter.

8. A computing system for managing model drift in a machine learning model, the computing system comprising:
one or more hardware processors;
a data extractor executable by the one or more hardware processors and configured to extract test data and training data from an ordered data stream, the test data being extracted from a detection window in the ordered data stream and the training data being extracted from a sliding reference window that precedes the detection window in the ordered data stream;
a doubly robust causal learning outcome predictor executable by the one or more hardware processors and configured to predict doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data;
a concept drift detector executable by the one or more hardware processors and configured to measure concept drift between the test data and the training data with respect to the machine learning model, wherein the concept drift is measured as an expectation of differences between the doubly robust outcomes for the ordered data stream and the doubly robust outcomes for the training data;
an adversarial feature selector executable by the one or more hardware processors and configured to select retraining feature vectors from feature vectors of the ordered data stream; and
a machine learning model retrainer executable by the one or more hardware processors and configured to retrain the machine learning model using the retraining feature vectors.

9. The computing system of claim 8, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

10. The computing system of claim 9, wherein the inverse propensity weighting of the residuals is based on the treatments predicted based on the controls of the ordered data stream.

11. The computing system of claim 8, wherein the adversarial feature selector is further configured to select the retraining feature vectors based on scores generated by an adversarial feature classifier.

12. The computing system of claim 11, wherein the adversarial feature selector is further configured to select the retraining feature vectors based on an area-under-the-curve (AUC) score generated by the adversarial feature classifier and an AUC condition hyperparameter.

13. The computing system of claim 11, wherein the adversarial feature selector is further configured to select the retraining feature vectors based on a raw feature importance value and a raw feature importance condition hyperparameter.

14. The computing system of claim 11, wherein the adversarial feature selector is further configured to select the retraining feature vectors based on a raw permutation feature importance value and a raw permutation feature importance condition hyperparameter.

15. One or more tangible processor-readable storage media embodied with instructions for executing on one or more processors and circuits of a computing device a process of managing model drift in a machine learning model, the process comprising:
extracting test data and training data from an ordered data stream, the test data being extracted from a detection window in the ordered data stream and the training data being extracted from a sliding reference window that precedes the detection window in the ordered data stream;
predicting doubly robust outcomes for the ordered data stream based on a combination of treatments predicted based on controls of the ordered data stream and outcomes predicted based on the treatments and the controls of the ordered data stream, wherein the doubly robust outcomes include doubly robust outcomes for the test data and doubly robust outcomes for the training data;
measuring concept drift between the test data and the training data with respect to the machine learning model, wherein the concept drift is measured as an expectation of differences between the doubly robust outcomes for the ordered data stream and the doubly robust outcomes for the training data;
selecting retraining feature vectors from feature vectors of the ordered data stream, based on the concept drift being measured to satisfy a retraining condition; and
retraining the machine learning model using the retraining feature vectors, based on the concept drift being measured to satisfy the retraining condition.

16. The one or more tangible processor-readable storage media of claim 15, wherein the training data includes observed outcomes, and the doubly robust outcomes predicted for the ordered data stream are based on the outcomes predicted based on the treatments and the controls of the ordered data stream added to an inverse propensity weighting of residuals between the observed outcomes and the outcomes predicted based on the treatments and the controls of the ordered data stream.

17. The one or more tangible processor-readable storage media of claim 16, wherein the inverse propensity weighting of the residuals is based on the treatments predicted based on the controls of the ordered data stream.

18. The one or more tangible processor-readable storage media of claim 15, wherein the selecting operation comprises:
selecting the retraining feature vectors based on scores generated by an adversarial feature classifier.

19. The one or more tangible processor-readable storage media of claim 18, wherein the selecting operation comprises:
selecting the retraining feature vectors based on an area-under-the-curve (AUC) score generated by the adversarial feature classifier and an AUC condition hyperparameter.

20. The one or more tangible processor-readable storage media of claim 18, wherein the selecting operation comprises:
selecting the retraining feature vectors based on a raw permutation feature importance value and a raw permutation feature importance condition hyperparameter.
